(19) United States
(12) Patent Application Publication
(10) Pub. No.: US 2026/0135807 A1
(43) Pub. Date: May 14, 2026

(54) DISTRIBUTED PATH GENERATION SYSTEM WITH PARALLEL LIST MANAGEMENT FOR URL SHORTENING

(71) Applicant: VERIZON PATENT AND LICENSING INC., Basking Ridge, NJ (US)

(72) Inventors: Dominick LAMASTRA, Scotch Plains, NJ (US); Amit KAVURI, Middlesex, NJ (US); Hui LI, Madison, NJ (US); Srinivasa KANIGANTI, Frisco, TX (US); Neal Jayesh PATEL, Parsippany, NJ (US)

(73) Assignee: VERIZON PATENT AND LICENSING INC., Basking Ridge, NJ (US)

(21) Appl. No.: 18/946,670

(22) Filed: Nov. 13, 2024

(51) Int. Cl. H04L 47/122; G06F 16/955; H04L 45/12; H04L 47/125

(52) U.S. Cl. CPC H04L 47/122; G06F 16/9566; H04L 45/12; H04L 47/125

(57) ABSTRACT

A device may initialize a first list and a second list in a memory device, the first list and the second list storing shortened uniform resource locator (URL) paths. A device may fill the first list with a first set of paths and the second list with a second set of paths. A device may distribute paths from the first list while maintaining the first list as active and the second list as inactive. A device may monitor a capacity threshold of the first list during path distribution. A device may switch the second list to active and the first list to inactive in response to the first list reaching the capacity threshold. A device may distribute paths from the second list while refilling the first list with a third set of paths.

### BACKGROUND

URL shortening systems operate in distributed computing environments where multiple data centers process and manage shortened URLs. These systems typically utilize various components including path generators, storage systems, and distribution mechanisms to create and manage shortened URLs.

### BRIEF DESCRIPTION OF THE DRAWINGS

FIG. 1 illustrates a distributed path generation system architecture.

FIG. 2 illustrates a process flow showing interactions between a collector, path lists, distributor, and backup bank.

FIG. 3 is a flow diagram illustrating a path generation and security process.

FIG. 4 is a flow diagram of the storage and path management process, incorporating numeric path handling, validation, and system health monitoring.

FIG. 5 is a block diagram of a computing device according to some embodiments of the disclosure.

### DETAILED DESCRIPTION

Traditional URL shortening systems rely heavily on database operations to ensure path uniqueness, requiring continuous lookup operations that create substantial input/output (I/O) overhead and storage requirements. As these systems scale, the growing size of lookup tables leads to degraded database performance, increased storage costs, and longer path generation latency. Additionally, the requirement to replicate these large lookup tables across multiple data centers creates significant network overhead and introduces potential consistency challenges.

The present disclosure provides a technical solution that eliminates the need for database lookups through a novel path generation system combining Linear Feedback Shift Register (LFSR) algorithms with substitution-permutation networks. The system implements a dual-list management architecture within a memory space (e.g., Java Virual Machine memory space), where one list actively distributes paths while another list is refilled, significantly reducing I/O operations and memory requirements. This approach transforms what was previously a storage-intensive operation into a computationally efficient process.

The system further improves distributed computing efficiency through a factorial-based partitioning scheme that enables data centers to operate independently without synchronization overhead. Each data center maintains its own path space through modular arithmetic operations, eliminating the need for cross-datacenter communication during path generation while ensuring global uniqueness. The architecture includes a backup path bank system that maintains operational continuity during virtual machine failures or high-load scenarios without requiring additional database resources, thereby improving system resilience while maintaining memory efficiency.

In one implementation, the disclosed system manages URL path generation through a dual-list architecture stored in memory. The system initializes and maintains two lists, each storing shortened URL paths. Initially, both lists are filled with unique sets of paths. During operation, one list remains active for path distribution while the other remains inactive. The system continuously monitors the active list's capacity threshold. When this threshold is reached, the system performs a switch operation, activating the previously inactive list while deactivating the depleted list. During this transition, the system begins distributing paths from the newly activated list while simultaneously refilling the deactivated list with a fresh set of paths.

Path generation employs an LFSR generator that implements a primitive binary polynomial-based algorithm. Each generated path undergoes a substitution-permutation network transformation before being added to either list. The system validates all transformed paths against a pattern database to ensure they meet security requirements.

The system implements path space partitioning across multiple data centers using a factorial-based approach. Each generated path undergoes validation using modular arithmetic to ensure it falls within the assigned partition for its current data center, maintaining global uniqueness without requiring cross-datacenter communication.

For fault tolerance, the system maintains a backup path bank in persistent storage while continuously monitoring virtual machine (VM) health metrics. As used herein, a VM refers to a virtualized execution environment. In some implementations, a VM can comprise a language-specific environment, such as the Java Virtual Machine (VM), although the disclosure is not limited as such. Further, while VMs are utilized, in some implementations, the embodiments may be applied to hardware environments or other containerized environments. Upon detecting VM health issues, the system automatically switches to distributing paths from the backup bank until normal operation can resume.

The list filling process incorporates sophisticated tracking mechanisms, maintaining both an attempts counter and a cycle iterations counter. Each generated path must satisfy a modular relationship between these counters, with paths failing this validation being skipped to enhance randomness and distribution quality.

Security is maintained through path encryption using a reversible substitution permutation algorithm prior to distribution.

The system includes specialized handling for bulk path requests that exceed configured thresholds. When such requests are received, the system switches to a streaming mode for path generation, implementing flow control mechanisms to prevent system overload while maintaining path uniqueness guarantees.

The disclosure further describes devices and computer-readable media for performing the above methods and operations.

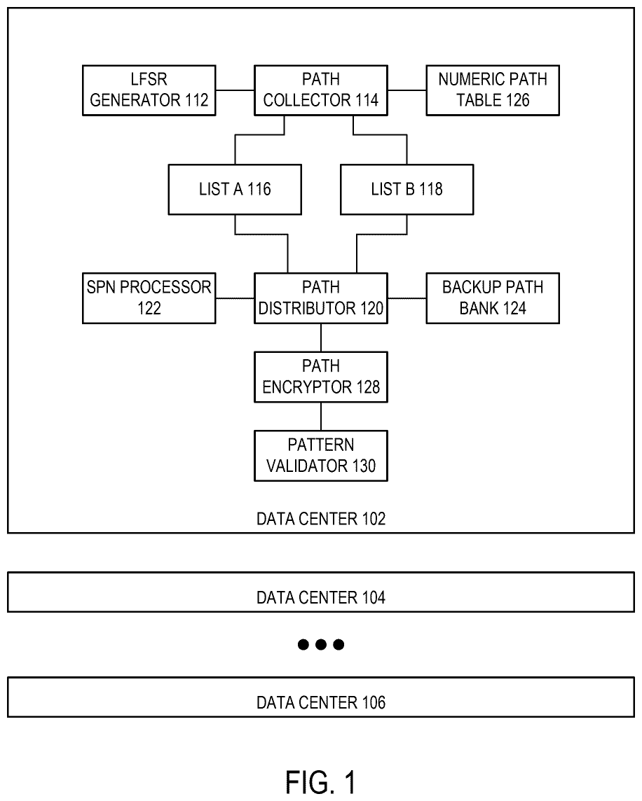

FIG. 1 illustrates a distributed path generation system architecture comprising three data centers (data center 102, data center 104, and data center 106). Each data center implements components that generate paths independently while maintaining global uniqueness. While details of only data center 102, in some implementations data center 104 and data center 106 may include similar or identical sub-components. Additionally, while only three data centers are illustrated, the system may include more or fewer data centers.

In the illustrated system, data center 102 can include several components. A linear feedback shift register (LFSR) generator 112 produces numeric values using bit manipulation operations. The generator can implement a polynomial-based algorithm within a finite field, ensuring complete value coverage before repetition. LFSR generator 112 can be communicatively coupled to path collector 114, which processes these values into usable paths.

Path collector 114 can maintain two memory structures within memory: list A 116 and list B 118. In an implementation, these lists operate in alternation, when list A 116 is actively providing paths to path distributor 120, list B 118 can undergo refilling operations, and vice versa. This approach enables continuous path availability without database operations.

The system can further include a substitution permutation network (SPN) processor 122 which can apply transformations to paths before distribution. SPN processor 122 can perform character substitutions and permutations based on configured parameters. These transformations can occur in memory and are deterministic for each input. In an implementation, SPN processors across all data centers can apply identical transformation rules but operate on different input sets due to the partitioned path space.

A backup path bank 124 can be communicatively coupled to path distributor 120 and can provide fault tolerance for high-load scenarios. Backup path bank 124 can maintain a reserve of pre-generated paths that can be accessed when the primary system experiences virtual machine issues, or during bulk requests.

The numeric path table 126 can be configured to store state information for LFSR generator 112, including the current numeric path value, attempt count, and cycle iterations. This table can interface with path collector 114 to ensure proper initialization and state management.

In an implementation, path distributor 120 can receive paths from either the active list (A 116 or B 118) or backup path bank 124, and pattern validator 130 performs final validation checks for paths that could be predictable or difficult to use, such as repeated characters or common words.

In some implementations, each data center's LFSR generator can operate within a mathematically partitioned space using modular arithmetic. The system can implement a factorial-based partitioning scheme that divides the total path space into non-overlapping regions, with each data center assigned a specific region based on its identifier. Path collectors can implement an attempts-based validation system to verify paths fall within their assigned ranges using modular arithmetic operations.

The backup path banks in each data center can maintain independent stores of pre-generated paths. These paths can be generated during normal operation when system resources permit and adhere to the same space partitioning rules as the primary generation system. The numeric path tables can track independent sets of state information, storing the minimum data required for proper path generation.

Path encryptors operate independently within each data center but can use synchronized encryption keys. This synchronization can occur through a separate key management system not shown in the figure. Pattern validators can implement identical validation rules across all data centers, checking specifically for patterns that could make paths predictable or difficult to use.

In one implementation, the system can generate shortened URLs containing an eight-character random path suffix (e.g., “tRekf8mN” in “example.com/tRekf8mN”) that can be used to provide links for authentication. For authentication workflows, the system can add this suffix to base authentication URLs, creating single-use authentication links that provide direct system access. The factorial-based partitioning enables data centers to independently generate these eight-character paths without database lookups or cross-datacenter communication, while the LFSR-based generation with modular validation ensures paths will not repeat within the authentication link's validity period. The dual-list architecture with backup path bank ensures continuous path availability for authentication link generation even during system disruptions or maintenance. This implementation maintains path uniqueness through computational methods rather than storage operations, enabling rapid path generation for latency-sensitive authentication workflows while eliminating the need to store and query historical path databases.

The illustrated architecture enables each data center to operate independently while maintaining global path uniqueness through mathematical guarantees rather than database operations. The system can maintain these guarantees during both normal operations and failure scenarios through the backup path banks and state management in the numeric path tables. As illustrated, the combination of LFSR-based generation, dual-list management, and factorial-based space partitioning eliminates the need for cross-data center synchronization during normal operations.

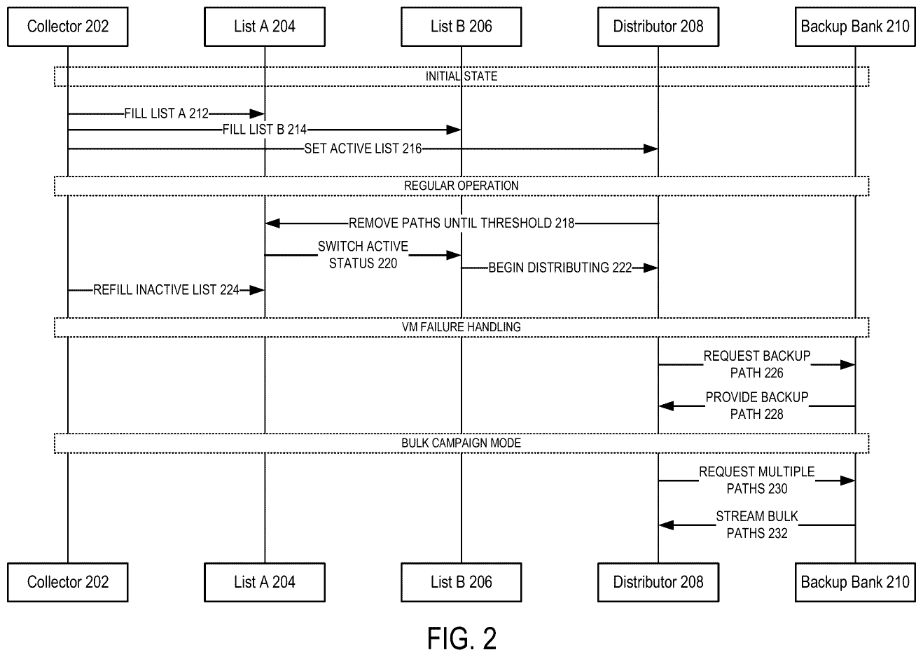

FIG. 2 illustrates a process flow showing interactions between a collector 202, list A 204, list B 206, distributor 208, and backup bank 210.

In step 212, the method can include filling list A 204 with an initial set of paths.

In some implementations, the collector 202 can generate paths using the LFSR-based generation process and validates each path against the data center's assigned range. In some implementations, the collector can employ various generation parameters, like different skip factors to enhance randomness. In some implementations, the filling process can continue until list A reaches its configured capacity, which may be adjusted based on system resources and expected path distribution rates.

In step 214, the method can include filling list B with a separate set of paths.

In some implementations, the collector can ensure that no paths are duplicated between lists by maintaining separate LFSR states for each list's generation process. The filling of list B can occur concurrently with list A's filling, or it may be sequential, depending on system resource availability. In some implementations, the system can implement different capacity limits for list B compared to list A, allowing for asymmetric list management.

In step 216, the method can include setting list A as the active distribution list.

In some implementations, this activation process can include updating internal state markers and establishing connections between list A and the distributor. The system can implement various activation policies, such as gradual activation to prevent sudden load changes or immediate activation for faster response times.

In step 218, the method can include monitoring and removing paths from list A until it reaches a capacity threshold (e.g., a 50% capacity threshold).

In some implementations, the distributor can implement various distribution strategies, such as random selection or sequential access, to maintain uniform path usage. The system can track the rate of path consumption and may adjust its refill triggers based on observed usage patterns. In some implementations, a baseline 50% threshold can be dynamically adjusted based on system load, performance metrics, or other operational factors.

In step 220, the method can include switching the active status from list A to list B.

In some implementations, this switching process can utilize atomic operations to ensure no paths are lost or duplicated during the transition. The system can implement various switching protocols, such as graceful switching that allows in-flight requests to complete or immediate switching for faster response to system events.

In step 222, the method can include beginning path distribution from list B.

In some implementations, the distributor can implement path selection algorithms that ensure uniform usage across the available paths. The distribution process can include additional validation steps to verify path validity at the time of distribution. In some implementations, the system can implement various distribution optimization strategies, such as path caching or predictive loading, to improve performance under different load conditions.

In step 224, the method can include refilling the now-inactive list A. The list that was just being used will now need to be refilled. In some implementations, this refill operation occurs after switching active status between lists, if list A was active and becomes inactive, it will be refilled, and similarly if list B was active and becomes inactive, it will be refilled. This alternating pattern ensures continuous path availability while minimizing system overhead.

In some implementations, this refill operation can run concurrently with list B's distribution activities, ensuring continuous path availability. The refill process can implement different generation parameters than the initial fill, allowing the system to adapt to changing requirements or conditions.

In step 226, the method can include requesting a backup path from the backup bank.

In some implementations, this step can occur when the system detects potential issues with the primary path generation or distribution mechanisms. The backup request can be triggered by various conditions, such as VM (e.g., JVM) memory load, excessive generation latency, or system health metrics.

In step 228, the method can include providing a backup path from the backup bank.

In some implementations, the backup bank can utilize path selection strategies to maintain path uniqueness and security requirements. The backup provision process can include additional validation steps to ensure backup paths meet current system requirements.

In step 230, the method can include requesting multiple paths for bulk campaign operations.

In some implementations, this step can utilize specialized handling for high-volume path requests that might overwhelm the normal distribution process. The bulk request process can include optimization strategies such as batch generation or parallel processing to maintain system performance.

In step 232, the method can include streaming bulk paths from the backup bank.

In some implementations, this streaming process implements flow control mechanisms to prevent system overload while maintaining path uniqueness guarantees. The backup bank can implement different streaming strategies based on request volume and system capabilities.

In yet another implementation, the dual-list architecture, combined with the backup bank, enables the system to maintain high availability while efficiently managing system resources. The process implements various fallback mechanisms and optimization strategies at each step, ensuring operation under diverse conditions. Additionally, the continuous cycle of list filling, distribution, and switching maintains constant path availability while minimizing resource usage.

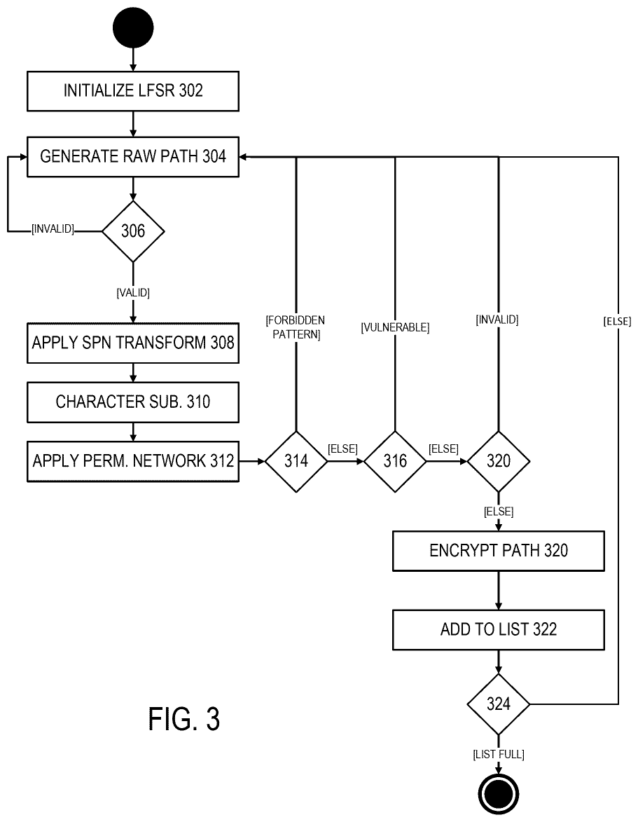

FIG. 3 is a flow diagram illustrating a path generation and security process.

In step 302, the method can include initializing the LFSR generator with appropriate polynomial coefficients and initial state.

In some implementations, step 302 may include preliminary steps such as preparing the system state and loading configuration parameters. The system can initialize multiple parallel generation processes based on resource availability and load requirements. In some implementations, the initialization process includes loading the current LFSR state from persistent storage and verifying system readiness for generation operations.

In some implementations, the initialization process implements various polynomial selections based on the desired path space size and uniqueness requirements. The system can employ different initialization strategies depending on whether this is a first-time initialization or a restart scenario. In some implementations, the LFSR initialization includes verification steps to ensure the selected polynomial provides the required cycle length and randomness properties.

In step 304, the method can include generating a raw path using the LFSR bit manipulation operations.

In some implementations, the generation process implements the configured polynomial operations through bitwise operations for efficiency. The system can employ different bit manipulation strategies based on the target architecture's capabilities. In some implementations, the raw path generation includes intermediate state tracking to maintain the LFSR's position in its cycle.

In particular implementations, the LFSR bit manipulation can include performing a series of shift operations on an input value based on a primitive binary polynomial. For example, given a polynomial of degree n (where n represents the number of bits), the system performs right shift operations corresponding to each term in the polynomial, combines these shifted values using exclusive-OR (XOR) operations, and then performs a final left shift operation to generate the next value in the sequence.

In some implementations, the bit manipulation operation can be expressed as: current_value>>1|((current_value>>n)⊕(current_value>>1)⊕(current_value>>0) & 1)<<(degree−1), where ‘>>’ represents a right shift operation, ‘<<’ represents a left shift operation, ‘⊕’ represents an XOR operation, and ‘&’ represents a bitwise AND operation.

The system may track both the number of attempts and the number of cycle iterations during path generation. In some implementations, the system validates generated paths using a modular relationship between attempts and cycle iterations, expressed as:
attempts modulo N equals iterations, where N is a configurable parameter that affects path distribution patterns.

In some implementations, the LFSR generates a sequence of values that does not repeat until all possible values in the range of 1 to 2\hat{ }n−1 have been generated, where n is the degree of the primitive binary polynomial. This property ensures complete coverage of the available path space before any repetition occurs.

The system may implement different skip factors during path generation to enhance randomness. For example, after generating a valid path, the system may apply the bit manipulation operation multiple times to skip a configurable number of potential paths before selecting the next candidate path.

In step 306, the method can include performing a datacenter range check on the generated path.

In some implementations, this validation step implements modular arithmetic operations to determine if the path falls within the current datacenter's assigned range. The system can employ different range calculation strategies based on the total number of active datacenters.

In particular implementations, the system utilizes a factorial-based partitioning scheme for assigning ranges to datacenters. For example, the system may use 5-factorial (120) as a base constant to enable flexible partitioning that supports up to 5 datacenters. Each datacenter is assigned a specific subrange within this space, such as 0 -40 for a first datacenter, 40-80 for a second datacenter, and 80-120 for a third datacenter.

The range check can include performing a modular division operation on the numeric path value using the factorial-based constant as the divisor. The resulting remainder determines which datacenter may use the path. For example, if the numeric path modulo 120 falls within a datacenter's assigned range (e.g., 0-40), that datacenter may use the path while other datacenters must reject it.

In some implementations, when adding or removing datacenters, the system updates range assignments by scanning the numeric path tables across all datacenters to identify the highest attempt count and cycle iteration values. The system then uses these values to ensure consistent path generation resumption without risking path collisions during datacenter reconfiguration.

The system may implement atomic range validation operations to handle concurrent path generation across multiple servers within a single datacenter. In some implementations, a single producer application per datacenter performs range validation to prevent race conditions that could compromise the uniqueness guarantees provided by the range partitioning.

When a datacenter fails, the system can handle path generation through two fallback mechanisms. In some implementations, the system can temporarily retrieve paths from other active datacenters'assigned ranges, maintaining path uniqueness through the factorial-based partitioning scheme. In other implementations, the system can retrieve paths from the backup path bank, which maintains a pre-generated store of valid paths for emergency scenarios. This dual-fallback approach ensures continuous path availability without requiring complex range redistribution operations. The choice between using other datacenters or the backup path bank can be determined by factors such as network latency, current system load, and the expected duration of the datacenter outage.

In some implementations, the range validation includes boundary checks to ensure proper spacing between datacenter ranges, preventing edge cases where paths near range boundaries could potentially overlap. The system may implement buffer zones between ranges to accommodate future datacenter additions without requiring complete reallocation of the path space.

In step 308, the method can include applying an SPN transformation to valid paths.

In some implementations, the transformation process implements multiple rounds of substitution and permutation operations according to configured parameters. The system can employ different transformation strategies based on security requirements and performance constraints.

In particular implementations, the SPN transformation serves as a security layer independent of the core path generation process. The transformation parameters are stored in configuration files rather than within the Java code, preventing internal attackers from easily determining the transformation patterns even with access to the source code.

The SPN process can implement a multi-round transformation where each round consists of two phases. In the first phase, characters are substituted according to a mapping table. In the second phase, the positions of the characters are permuted according to a shuffling pattern. The system may apply these rounds repeatedly, with each round potentially using different substitution tables and permutation patterns.

In some implementations, the substitution phase uses multiple substitution tables in sequence, where the output of one substitution becomes the input for the next. For example, if character ‘C’ is mapped to ‘X’ in the first substitution, and ‘X’ is mapped to ‘G’ in the second substitution, the final output would be ‘G’. This chaining of substitutions increases the complexity of reversing the transformation.

In some implementations, this step implements configurable substitution tables that map input characters to output characters. The system can employ different substitution strategies based on security requirements and allowed character sets. In some implementations, the substitution process includes validation to ensure all substituted characters remain within the allowed character space.

In particular implementations, the character substitution process operates on eight-character paths using a set of dynamic substitution tables. These tables implement one-to-one character mappings where each input character corresponds to exactly one output character, ensuring the substitution operation is reversible.

The system may implement multiple layers of substitution, where the output of one substitution table becomes the input to another. For example, the first layer might substitute numeric characters while preserving alphabetic characters, followed by a second layer that substitutes alphabetic characters while preserving the previously substituted numeric values.

In some implementations, the substitution tables are periodically rotated according to a predetermined schedule or in response to system events. The rotation schedule is synchronized across all datacenters to maintain consistent substitution patterns while preventing pattern prediction through observation.

In some implementations, the permutation process implements various shuffling algorithms to reorder the characters in a deterministic but unpredictable way. The system can employ different permutation strategies based on the path length and security requirements.

In particular implementations, the permutation network operates on fixed-length eight-character sequences using a series of swap operations. Each swap operation exchanges two character positions according to a predetermined pattern derived from mathematical properties of the original numeric path value, ensuring the permutation remains deterministic while appearing random to observers.

The system may implement a multi-stage permutation process where each stage applies a different shuffling pattern. For example, a first stage might swap adjacent characters based on their position modulo 2, while a second stage performs longer-distance swaps based on position modulo 3, and a third stage applies a final transformation based on the aggregate results of previous swaps.

In some implementations, the permutation network includes position-dependent transformations where the swap patterns vary based on the character positions being exchanged. This approach prevents attackers from identifying pattern regularities by observing multiple paths generated in sequence.

The permutation process can implement different shuffling strategies based on system-wide configuration parameters. These parameters are stored separately from the application code and can be updated without requiring application redeployment, allowing the system to adapt its security properties without service interruption.

In some implementations, the permutation network maintains internal state information to track the sequence of transformations applied to each path. This state information enables the system to validate the uniqueness of permutation patterns while ensuring that no two paths undergo identical transformation sequences.

In some implementations, the SPN transformation includes validation steps between rounds to ensure the transformed path maintains required properties such as allowed character sets and format constraints. If a transformation round produces an invalid result, the system may apply an alternate transformation pattern rather than rejecting the path entirely.

The system may implement different transformation strategies based on the path's intended use. For example, paths intended for high-security applications may undergo additional transformation rounds, while paths for internal use may use a simplified transformation process to reduce computational overhead.

In particular implementations, the SPN transformation maintains consistency across all datacenters by using synchronized configuration parameters, but each datacenter applies the transformation independently. This approach ensures that paths remain unique across datacenters while maintaining the security benefits of the transformation.

In step 314, the method can include performing pattern analysis on the transformed path.

In some implementations, this validation step implements various pattern detection algorithms to identify potentially problematic sequences. The system can employ different pattern matching strategies based on configurable rules and requirements. In some implementations, the pattern analysis includes checks for repeated characters, common words, and other undesirable patterns.

In some implementations, the pattern analysis process enforces specific validation rules against known problematic patterns. The system rejects paths containing three or more consecutive identical characters (e.g., “AAA” or “BBBB”) to prevent visually confusing sequences. Additionally, the system restricts character pair repetition, allowing a character to repeat only once within the path (e.g., “XYYX” would be rejected). Sequential patterns, such as consecutive alphabetical or numerical sequences (e.g., “ABCD” or “1234”), are forbidden to prevent predictable paths. The system also validates against symmetric patterns where the first half of the path mirrors the second half (e.g., “ABCCBA”), as these patterns could make paths more guessable. These core pattern rules ensure generated paths maintain both visual clarity and security properties while remaining user-friendly.

In some implementations, the pattern analysis process employs a multi-layer validation approach. The first layer examines character-level patterns, such as three or more consecutive identical characters or alternating character pairs that could create visually confusing sequences. The second layer analyzes numeric patterns that might make paths predictable, such as ascending or descending sequences. The third layer checks for common word patterns or substrings that could create unintended meanings.

In some implementations, the system may implement a sliding window analysis where subsequences of different lengths are examined for pattern violations. For example, the system might analyze windows of length 2 through 4 within the 8-character path, with each window size having its own set of pattern rules and thresholds.

In some implementations, the pattern analysis includes frequency distribution checks to ensure no single character or character pair appears more often than a configured threshold within a given time window across generated paths. This distribution analysis helps prevent patterns that might emerge across multiple paths even when individual paths appear random.

In some implementations, the pattern validation process can implement configurable rejection thresholds where paths exceeding certain pattern scores are automatically regenerated. These thresholds may be adjusted based on operational requirements and security policies without requiring system restart.

In some implementations, the system maintains pattern analysis statistics across all datacenters to identify and adjust for any systematic biases in the path generation process. These statistics are used to dynamically update pattern detection rules and thresholds while maintaining path uniqueness guarantees.

In step 316, the method can include performing a brute force resistance check on the path.

In some implementations, this security validation implements various analyses to ensure the path cannot be easily guessed through systematic attempts. The system can employ different resistance verification strategies based on current threat models. In some implementations, the brute force check includes analysis of character distribution and pattern predictability.

In particular implementations, the brute force resistance check evaluates paths against known attack patterns stored in a configurable rule set. The system analyzes the path's relationship to previously generated paths within the same numeric range to detect any mathematical progressions or patterns that could be exploited for prediction, such as simple incremental relationships or linear transformations between successive paths.

In some implementations, the system may implement entropy analysis on the path sequence, calculating both local entropy (within the individual path) and contextual entropy (across recent paths from the same datacenter). Paths that exhibit entropy values outside configured thresholds are rejected to maintain resistance against statistical analysis attacks.

In some implementations, the brute force check includes a polynomial cycle analysis that verifies the path's position within the LFSR sequence is sufficiently distant from both recently generated paths and predicted future paths. This distance is measured in terms of the number of LFSR iterations required to generate one path from another, with larger distances providing greater resistance to sequence prediction attacks.

In some implementations, the resistance verification process can implement different thresholds based on the path's intended use case. For example, paths generated for authenticated sessions may require higher entropy and greater polynomial distance than paths generated for public-facing URLs. The system maintains these varying security levels while ensuring all paths meet minimum resistance requirements.

In some implementations, the system maintains a rolling window of recently validated paths to perform temporal pattern analysis, ensuring that even paths that individually pass resistance checks don't create exploitable patterns when considered as a sequence. This temporal analysis helps prevent sophisticated attacks that might attempt to derive the underlying generation algorithm by observing multiple paths over time.

In step 318, the method can include performing an iteration check to verify the path's position in the generation cycle.

In some implementations, this validation step implements counting mechanisms to track LFSR cycle progression and ensure complete space coverage. The system can employ different iteration tracking strategies based on the configured polynomial and space requirements.

In particular implementations, the iteration check process maintains two key counters: an attempts counter tracking total generation attempts and a cycle iterations counter tracking complete cycles through the path space. The system validates paths using a modular relationship between these counters.

The system may implement cycle detection by maintaining a numeric path table that stores the current path value, number of attempts, and cycle iterations for each datacenter. When the LFSR sequence returns to its starting value, the cycle iterations counter increments, and this state is persisted to enable consistent path generation across system restarts.

In some implementations, the iteration check includes skip factor validation where paths are systematically skipped based on the current cycle position. For example, the system might skip N potential paths after each successful generation, where N varies based on the cycle iteration count to enhance randomness while maintaining complete coverage of the path space.

The iteration tracking process can implement different validation strategies when operating in different modes. During normal operation, paths must satisfy strict iteration requirements, while during recovery or high-load scenarios, the system may employ modified iteration criteria while maintaining basic uniqueness guarantees.

In some implementations, the method can optionally include encrypting the validated path. In some implementations, the encryption process implements standard cryptographic operations using configured keys and algorithms. The system can employ different encryption strategies based on security requirements and performance constraints.

In step 322, the method can include adding the processed path to the active list. In some implementations, this addition step implements thread-safe operations to maintain list integrity during concurrent operations. The system can employ different addition strategies based on list state and capacity requirements.

In step 324, the method can include checking if the current list has reached its capacity limit. In some implementations, this validation step implements configurable thresholds for list capacity. The system can employ different capacity checking strategies based on memory availability and performance requirements.

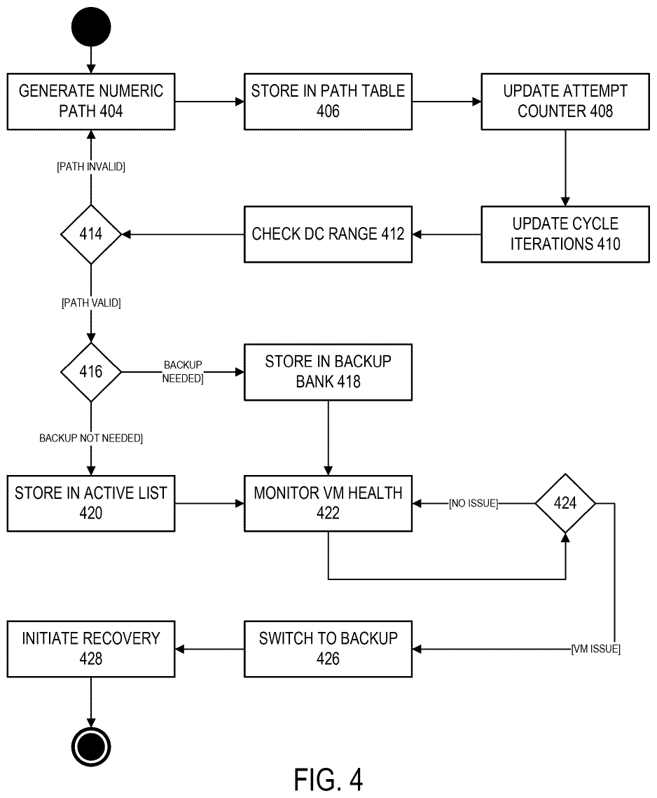

FIG. 4 illustrates a detailed flow diagram of the storage and path management process, incorporating numeric path handling, validation, and system health monitoring.

In step 404, the method can include generating a numeric path value using the LFSR algorithm.

In some implementations, the generation process implements bit manipulation operations based on the configured polynomial coefficients. The system can employ different generation strategies based on the current cycle position and iteration count. In some implementations, the numeric path generation includes state tracking to maintain proper progression through the finite field space defined by the LFSR polynomial.

In step 408, the method can include updating the attempts counter for the current generation cycle.

In some implementations, this counting process implements atomic operations to maintain accuracy during concurrent operations. The system can employ different counting strategies based on the configured threshold values and cycle parameters. In particular implementations, the attempts counter is maintained using synchronized increment operations within each datacenter's numeric path table row. The counter tracks both successful and failed path generation attempts, incrementing regardless of whether a path is accepted or rejected by subsequent validation steps. When the counter reaches a value that, when divided by 16 (the configured cycle length), yields no remainder, the system triggers a cycle iteration update. The attempts counter works in conjunction with the modular validation formula (attempts modulo 4 equals iterations) to ensure paths are selected with appropriate spacing throughout the generation cycle, preventing clustering of selected paths while maintaining the system's uniqueness guarantees across concurrent operations.

In step 410, the method can include updating the cycle iterations counter when a complete cycle is detected.

In some implementations, this iteration tracking implements modular arithmetic to detect cycle completion efficiently. The system can employ different iteration tracking strategies based on the configured polynomial and space requirements. In particular implementations, the cycle iterations counter increments when the LFSR sequence completes a full traversal of its path space, which is detected when the attempts counter modulo 16 equals 0. The system maintains this counter in the numeric path table alongside the attempts counter and current path value, using it as part of the path validation formula (attempts modulo 4 equals iterations) to ensure proper path spacing. When a cycle completes, the system performs additional validation to verify that the generated paths covered the expected range for the datacenter's assigned partition, calculated using the factorial-based range assignment (e.g., within 0-40 for a total space of 120). This cycle tracking enables the system to maintain consistent path generation patterns across system restarts while ensuring complete coverage of the available path space within each datacenter's assigned range.

In step 412, the method can include checking the datacenter range for the generated path. In some implementations, this range validation implements factorial-based arithmetic to determine valid ranges for each datacenter. The system can employ different range calculation strategies based on the total number of active datacenters.

In step 414, the method can include validating whether the path falls within the assigned range. In some implementations, this validation step implements modular arithmetic operations to efficiently determine range membership. The system can employ different validation strategies based on the configured range boundaries and partitioning scheme.

In step 416, the method can include determining whether backup storage is needed for the current path. In some implementations, this decision process implements configurable criteria based on system state and operational requirements. The system can employ different backup strategies based on current load conditions and system health metrics.

In step 418, the method can include storing the path in the backup path bank when backup storage is required. In some implementations, this storage operation implements efficient database operations optimized for backup scenarios. The system can employ different storage strategies based on the backup bank's current capacity and fill rate.

In step 420, the method can include storing the path in the active list when backup storage is not required. In some implementations, this storage operation implements memory-efficient operations within the JVM heap. The system can employ different storage strategies based on the current list state and capacity requirements.

In step 422, the method can include monitoring JVM health metrics. In some implementations, this monitoring process implements various system health checks including memory usage, garbage collection statistics, and processing latency. The system can employ different monitoring strategies based on the operational environment and performance requirements.

In step 424, the method can include detecting JVM health issues through the monitoring process. In some implementations, this detection step implements configurable thresholds for various health metrics. The system can employ different detection strategies based on the severity and type of health issues.

In step 406, the method can include storing the generated numeric path in the numeric path table if the JVM is health. Generally, step 406 may only be executed once the pathlist that is collecting is full. Further, in some implementations, step 406 may only be executed once during the operation of the method of FIG. 4 and may be bypassed while the JVM health is continuously monitored.

In some implementations, this storage operation implements efficient database operations to maintain generation state with minimal I/O overhead. The system can employ different storage strategies based on the database's performance characteristics and load conditions. In particular implementations, the numeric path table maintains rows keyed by datacenter identifier, where each row contains the current numeric path value, an attempts counter, and a cycle iterations counter. When a pathlist is done collecting after being under a threshold, that last known numeric path is encrypted and written to the DB.

In step 426, the method can include switching to backup path distribution when JVM issues are detected. In some implementations, this switching process implements failover procedures to maintain path availability during system issues. The system can employ different switching strategies based on the issue severity and available backup resources.

In some implementations, the backup path bank serves as a fallback mechanism during VM health issues, providing immediate path availability without requiring complex recovery procedures. When VM health metrics indicate potential issues (such as memory pressure or excessive garbage collection), the method can first attempt to complete in-flight path distributions before initiating the switch to backup path distribution. The backup path bank maintains a pre-generated store of validated paths that have already undergone all necessary pattern checks and range validations, allowing for immediate distribution without additional processing overhead.

In some implementations, the method can use a staged approach to backup path utilization. Initially, it may begin pulling paths from the backup bank while attempting to resolve the VM health issues in the background. If the VM health issues resolve quickly, the method can transition back to normal path generation and distribution. For prolonged VM health issues, the system can continue serving paths from the backup bank while implementing progressive backfill operations to maintain sufficient backup path availability.

In some implementations, the backup path bank may employ management strategies such as maintaining separate path ranges for different VM instances or implementing hierarchical path storage. This approach ensures that even during degraded VM operation, the system can continue serving valid, unique paths without compromising the quality or security of the generated paths.

In step 428, the method can include initiating recovery procedures to restore normal operation. In some implementations, this recovery process implements various healing operations based on the detected issue type. The system can employ different recovery strategies based on the system state and available resources.

In particular implementations, the backup path bank implements specialized synchronization mechanisms to handle race conditions during failover scenarios. When multiple servers within a datacenter attempt to access the backup bank simultaneously, the system employs an atomic read-modify-write operation where each path retrieval includes updating a status flag in the same transaction. This approach prevents duplicate path distribution even under high concurrency. The backup paths are pre-generated in batches during normal operation, with each batch assigned to a specific range within the datacenter's factorial-based partition. When a VM instance fails, other instances can immediately begin consuming backup paths from their pre-assigned ranges without requiring coordination. The system maintains separate backup path ranges for each VM instance, calculated as subdivisions of the datacenter's overall assigned range (e.g., if a datacenter is assigned range 0-40, and has two VM instances, they might be assigned backup ranges 0-20 and 20-40 respectively). This partitioning ensures that even during partial system failures where some VM instances continue normal operation while others fail over to backup paths, the system maintains its uniqueness guarantees without requiring cross-instance synchronization.

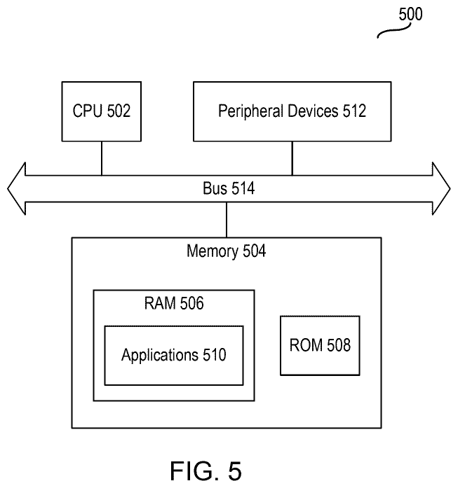

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present application is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
initializing a first list and a second list in a memory device, the first list and the second list storing shortened uniform resource locator (URL) paths;
filling the first list with a first set of paths and the second list with a second set of paths;
distributing paths from the first list while maintaining the first list as active and the second list as inactive;
monitoring a capacity threshold of the first list during path distribution;
switching the second list to active and the first list to inactive in response to the first list reaching the capacity threshold; and
distributing paths from the second list while refilling the first list with a third set of paths.

2. The method of claim 1, further comprising:
generating paths using a linear feedback shift register (LFSR) generator implementing a polynomial-based algorithm;
applying a substitution-permutation network transformation to each generated path prior to adding a given path to either the first list or the second list; and
validating each transformed path against a pattern database.

3. The method of claim 1, further comprising:
determining a factorial-based partition of a path space across multiple data centers; and
validating each generated path using modular arithmetic to determine that a given path falls within an assigned partition for a current data center.

4. The method of claim 1, further comprising:
maintaining a backup path bank in persistent storage;
monitoring Virtual Machine (VM) health metrics during path distribution;
detecting a VM health issue based on the VM health metrics; and
switching to path distribution from the backup path bank during the VM health issue.

5. The method of claim 1, wherein filling the first list and the second list comprises:
tracking an attempts counter and a cycle iterations counter for path generation;
validating each generated path based on a modular relationship between the attempts counter and the cycle iterations counter; and
skipping paths that fail the modular relationship.

6. The method of claim 1, further comprising:
transforming each path using a substitution permutation network prior to distribution; and
validating the path against brute force attack patterns.

7. The method of claim 1, further comprising:
receiving a bulk path request exceeding a threshold number of paths;
switching to a streaming mode for path generation; and
implementing flow control mechanisms during streaming to prevent system overload.

8. A non-transitory computer-readable storage medium for tangibly storing computer program instructions capable of being executed by a computer processor, the computer program instructions defining steps of:
initializing a first list and a second list in a memory device, the first list and the second list storing shortened uniform resource locator (URL) paths;
filling the first list with a first set of paths and the second list with a second set of paths;
distributing paths from the first list while maintaining the first list as active and the second list as inactive;
monitoring a capacity threshold of the first list during path distribution;
switching the second list to active and the first list to inactive in response to the first list reaching the capacity threshold; and
distributing paths from the second list while refilling the first list with a third set of paths.

9. The non-transitory computer-readable storage medium of claim 8, the steps further comprising:
generating paths using a linear feedback shift register (LFSR) generator implementing a polynomial-based algorithm;
applying a substitution-permutation network transformation to each generated path prior to adding a given path to either the first list or the second list; and
validating each transformed path against a pattern database.

10. The non-transitory computer-readable storage medium of claim 8, the steps further comprising:
determining a factorial-based partition of a path space across multiple data centers; and
validating each generated path using modular arithmetic to determine that a given path falls within an assigned partition for a current data center.

11. The non-transitory computer-readable storage medium of claim 8, the steps further comprising:
maintaining a backup path bank in persistent storage;
monitoring Virtual Machine (VM) health metrics during path distribution;
detecting a VM health issue based on the VM health metrics; and
switching to path distribution from the backup path bank during the VM health issue.

12. The non-transitory computer-readable storage medium of claim 8, wherein filling the first list and the second list comprises:
tracking an attempts counter and a cycle iterations counter for path generation;
validating each generated path based on a modular relationship between the attempts counter and the cycle iterations counter; and
skipping paths that fail the modular relationship.

13. The non-transitory computer-readable storage medium of claim 8, the steps further comprising:
transforming each path using a substitution permutation network prior to distribution; and
validating the path against brute force attack patterns.

14. The non-transitory computer-readable storage medium of claim 8, the steps further comprising:
receiving a bulk path request exceeding a threshold number of paths;
switching to a streaming mode for path generation; and
implementing flow control mechanisms during streaming to prevent system overload.

15. A device comprising:
a processor configured for:
initializing a first list and a second list in a memory device, the first list and the second list storing shortened uniform resource locator (URL) paths;
filling the first list with a first set of paths and the second list with a second set of paths;
distributing paths from the first list while maintaining the first list as active and the second list as inactive;
monitoring a capacity threshold of the first list during path distribution;
switching the second list to active and the first list to inactive in response to the first list reaching the capacity threshold; and
distributing paths from the second list while refilling the first list with a third set of paths.

16. The device of claim 15, the processor further configured for:
generating paths using a linear feedback shift register (LFSR) generator implementing a polynomial-based algorithm;
applying a substitution-permutation network transformation to each generated path prior to adding a given path to either the first list or the second list; and
validating each transformed path against a pattern database.

17. The device of claim 15, the processor further configured for:
determining a factorial-based partition of a path space across multiple data centers; and
validating each generated path using modular arithmetic to determine that a given path falls within an assigned partition for a current data center.

18. The device of claim 15, the processor further configured for:
maintaining a backup path bank in persistent storage;
monitoring Virtual Machine (VM) health metrics during path distribution;
detecting a VM health issue based on the VM health metrics; and
switching to path distribution from the backup path bank during the VM health issue.

19. The device of claim 15, wherein filling the first list and the second list comprises:
tracking an attempts counter and a cycle iterations counter for path generation;
validating each generated path based on a modular relationship between the attempts counter and the cycle iterations counter; and
skipping paths that fail the modular relationship.

20. The device of claim 15, the processor further configured for:
transforming each path using a substitution permutation network prior to distribution; and
validating the path against brute force attack patterns.
